(19) United States
(12) Patent Application Publication
(10) Pub. No.: US 2026/0003350 A1
(43) Pub. Date: Jan. 1, 2026

(54) RECORDING MEDIUM, PROCEDURE GENERATION DEVICE, AND PROCEDURE GENERATION METHOD

(71) Applicant: Mitsubishi Electric Corporation, Tokyo (JP)

(72) Inventors: Shogo MORITA, Tokyo (JP); Daiki NAKAHARA, Tokyo (JP)

(73) Assignee: Mitsubishi Electric Corporation, Tokyo (JP)

(21) Appl. No.: 19/117,087

(22) PCT Filed: Mar. 14, 2023
(86) PCT No.: PCT/JP2023/009884

§ 371 Date: Mar. 31, 2025

(51) Int. Cl. G05B 23/02

(52) U.S. Cl. CPC G05B 23/0264; G05B 23/0221

(57) ABSTRACT

A program causes a procedure generation device to function as a generator. The generator generates a procedure including two or more events connected in series by performing, using an initial event occurring at an initial variable of multiple variables in a control program as a first event occurring at a first variable of the multiple variables, a connection operation of selecting, based on log information, a second event having a highest degree of relevance to the first event from events occurring at a second variable different from the first variable to connect the second event to the first event, and by repeating, using the second event connected in the connection operation performed previously as a new first event, the connection operation while excluding the initial event and an event connected directly or indirectly to the initial event from selection targets for a new second event.

### TECHNICAL FIELD

The present disclosure relates to a procedure generation program, a procedure generation device, and a procedure generation method.

### BACKGROUND ART

At a factory automation (FA) site, a programmable controller controls machines to perform various processes. The machines are controlled by the programmable controller executing a control program to follow the details defined in the control program.

The control program may be a target for verification to ensure that the programmable controller operates as expected by a user. The verification of the control program focuses on the relationships between variables included in the control program to examine effects of a specific event in a control process or to identify a cause of a specific event. Thus, techniques have been developed for extracting the relationships between the variables based on the control program and their execution logs (see, for example, Patent Literature 1). Patent Literature 1 describes a technique for analyzing a source code of a control program to extract combinations of variables having dependencies and correcting the extracted dependencies based on the results of analyzing the execution logs.

### CITATION LIST

### Patent Literature

Patent Literature 1: Japanese Patent No. 6833129

### SUMMARY OF INVENTION

### Technical Problem

In the control program including many variables, one variable may have dependencies with numerous other variables. This increases the number of combinations of variables extracted with the technique described in Patent Literature 1. Although the dependencies have been corrected based on the results of analyzing the execution logs, the user may be provided with excessively complicated relationships between variables and may thus have difficulty in a verification operation. The workload of the verification operation of the control program executable by the programmable controller is thus to be reduced.

Under such circumstances, an objective of the present disclosure is to reduce the workload of a verification operation of a control program executable by a programmable controller.

### Solution to Problem

To achieve the above objective, a procedure generation program according to an aspect of the present disclosure causes a computer to function as log acquisition means for acquiring log information indicating transitions of values of a plurality of variables in a control program when the control program for controlling a machine is executed by a programmable controller, and generation means for generating a procedure including two or more events connected in series to generate an event flowchart illustrating the generated procedure by performing, using an initial event occurring at an initial variable of the plurality of variables as a first event occurring at a first variable of the plurality of variables, a connection operation of selecting, based on the log information, a second event having a highest degree of relevance to the first event from events occurring at a second variable different from the first variable to connect the second event to the first event, and by repeating, using the second event connected in the connection operation performed previously as a new first event, the connection operation while excluding the initial event and an event connected directly or indirectly to the initial event from selection targets for a new second event.

### Advantageous Effects of Invention

The generation means in the above aspect of the present disclosure generates a procedure including two or more events connected in series by repeating the connection operation while excluding the initial event and an event connected directly or indirectly to the initial event from selection targets for a new second event. This avoids a large number of combinations of variables included in the control program to be in the procedure, and thus can reduce the workload of a verification operation of the control program executable by the programmable controller.

### BRIEF DESCRIPTION OF DRAWINGS

FIG. 1 is a diagram illustrating a relationship among a procedure generation device according to Embodiment 1, a programmable logic controller (PLC), and a machine in Embodiment 1;

FIG. 2 is a diagram of an example control program in Embodiment 1;

FIG. 3 is a block diagram of the procedure generation device according to Embodiment 1, illustrating the hardware configuration;

FIG. 4 is a functional block diagram of the procedure generation device according to Embodiment 1;

FIG. 5 is a table of example log information in Embodiment 1;

FIG. 6 is a flowchart illustrating a procedure generation process in Embodiment 1;

FIG. 7 is a flowchart illustrating a preparation process in Embodiment 1;

FIG. 8 is a table of example representative values and example values of indicators calculated in the preparation process in Embodiment 1;

FIG. 9 is a diagram of an example of specifying an initial event in Embodiment 1;

FIG. 10 is a first diagram of an example of connecting events in Embodiment 1;

FIG. 11 is a second diagram of an example of connecting events in Embodiment 1;

FIG. 12 is a third diagram of an example of connecting events in Embodiment 1;

FIG. 13 is an example event flowchart displayed on a user interface (UI) in the Embodiment 1;

FIG. 14 is a diagram describing exclusion of outliers in Embodiment 2;

FIG. 15 is a diagram describing clustering in Embodiment 2;

FIG. 16 is a table of example log information in Embodiment 3; and

FIG. 17 is a table of example frequencies counted in the preparation process in Embodiment 3.

### DESCRIPTION OF EMBODIMENTS

A procedure generation device according to one or more embodiments of the present disclosure is described in detail below with reference to the drawings.

### Embodiment 1

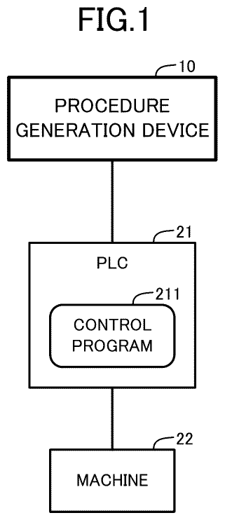

A procedure generation device 10 according to the present embodiment is connected to a programmable logic controller (PLC) 21 that is a programmable controller as illustrated in FIG. 1. The procedure generation device 10 corresponds to a control terminal to be used by a user to control the PLC 21. More specifically, the procedure generation device 10 generates procedures representing relationships between many variables included in a control program 211 executable by the PLC 21 and assists the user in debugging the control program 211. The procedure generation device 10 may be connected to the PLC 21 with a communication line such as a universal serial bus (USB) cable or through a field network.

The PLC 21 is a controller that executes the control program 211 written in advance to control a machine 22 at a factory. Although a single machine 22 is illustrated in FIG. 1 as a typical example, the PLC 21 may be connected to multiple machines 22 to control the multiple machines 22. For example, upon receiving, from the machine 22 as a sensor, a signal indicating that the machine 22 detects a workpiece conveyed on a conveyor belt, the PLC 21 transmits, based on the received signal, an operation command to another machine 22 as a robot and causes the other machine 22 to machine the workpiece. The PLC 21 may be connected to the machines 22 with a signal line for transmitting voltage signals or current signals, or through a field network.

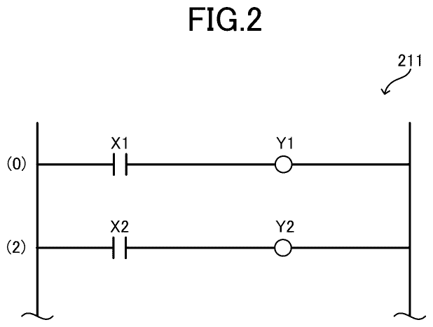

The control program 211 is created by the user using the procedure generation device 10 as a control terminal and is written into the PLC 21. The control program 211 is a sequence program written in a ladder language as illustrated in FIG. 2 in a simplified manner. The PLC 21 typically repeats a control process defined in the control program 211 to perform an equivalent process on each of many workpieces.

As illustrated in FIG. 2, the control program 211 includes input variables and output variables. Each input variable is associated with a name combining X indicating that the input variable is a signal received by the PLC 21 and a number for identifying the signal. Each output variable is associated with a name combining Y indicating that the output variable is a signal output from the PLC 21 to the machine 22 and a number for identifying the signal. In the example illustrated in FIG. 2, the value of an output variable Y1 is controlled based on an input variable X1, and the value of an output variable Y2 is controlled based on an input variable X2. For example, the value of an input variable X1 corresponds to a signal received from the machine 22 as a sensor, and the value of an output variable Y1 corresponds to a signal output to the machine 22 as a robot. Each variable value is stored in an area corresponding to the variable name in a memory included in the PLC 21. The variables processed in the control program 211 are also referred to as devices. These devices include a bit device indicating a 1-bit value corresponding to either an ON state or an OFF state and a word device indicating a value of a word size.

The verification operation of the control program 211 is to trace the relationship between an event occurring at a variable value and an event occurring at another variable value. The source code of the control program 211 can be referred to for understanding the relationships between the variables, but not all relationships represented by the complicated source code are easily understandable. In addition, not all relationships may be clarified in such an operation as breakdown maintenance. The procedure generation device 10 thus estimates, from multiple events occurring at the variables, a procedure including events that are expected to be most relevant to one another based on a history of the variable values during execution of the control program 211 and provides the estimated procedure to the user.

The relationships among variables and among events herein may be cause-and-effect relationships, dependencies, or subordination. Although no relationships are found in the source code of the control program 211, the relationships may be correlations, co-occurrence relationships, or confounding relationships that are defined in hindsight.

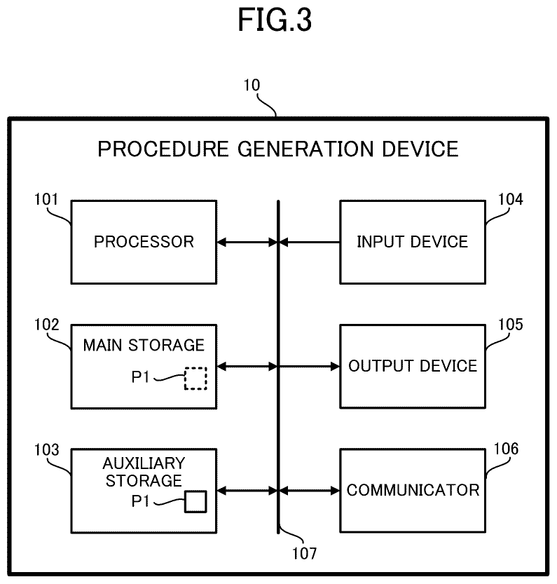

The procedure generation device 10 includes hardware components to function as a computer. More specifically, as illustrated in FIG. 3, the procedure generation device 10 includes a processor 101, a main storage 102, an auxiliary storage 103, an input device 104, an output device 105, and a communicator 106. The main storage 102, the auxiliary storage 103, the input device 104, the output device 105, and the communicator 106 are connected to the processor 101 with an internal bus 107.

The processor 101 includes a central processing unit (CPU) or a micro processing unit (MPU) as a processing circuit. The processor 101 executes a program P1 stored in the auxiliary storage 103 to implement various functions to perform the processes described later. The program P1 corresponds to an engineering tool. The program P1 corresponds to an example procedure generation program that causes the procedure generation device 10 to function as described later.

The main storage 102 includes a random-access memory (RAM). The program P1 is loaded from the auxiliary storage 103 into the main storage 102. The main storage 102 is used as a work area for the processor 101.

The auxiliary storage 103 includes a nonvolatile memory, such as an electrically erasable programmable read-only memory (EEPROM) and a hard disk drive (HDD). In addition to the program P1, the auxiliary storage 103 stores various types of data used in processing performed by the processor 101. The auxiliary storage 103 provides data used by the processor 101 to the processor 101 as instructed by the processor 101. The auxiliary storage 103 stores data provided from the processor 101.

The input device 104 includes input devices such as a hardware switch, an input key, a keyboard, and a pointing device. The input device 104 acquires information input by the user and provides the acquired information to the processor 101.

The output device 105 includes output devices such as a light-emitting diode (LED), a liquid crystal display (LCD), and a speaker. The output device 105 provides various types of information to the user as instructed by the processor 101.

The communicator 106 includes a communication interface circuit for communicating with external devices. The communicator 106 receives signals from the external devices and outputs data represented by these signals to the processor 101. The communicator 106 transmits signals representing data output from the processor 101 to the external devices.

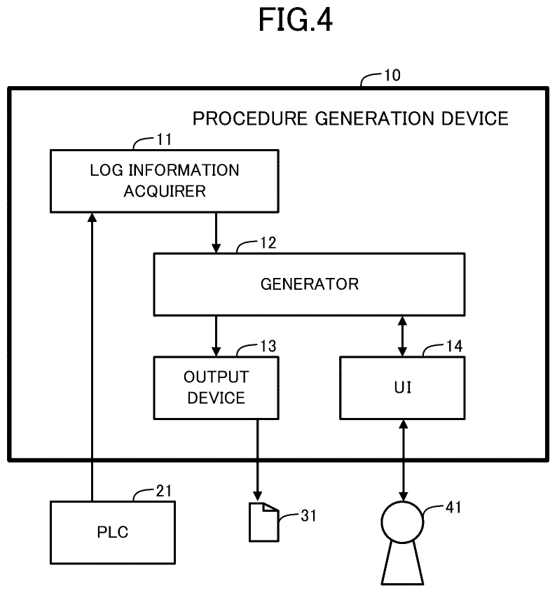

With the hardware components described above operating in cooperation with one another, the procedure generation device 10 performs various functions. More specifically, the procedure generation device 10 includes, as illustrated in FIG. 4, a log information acquirer 11 to acquire log information indicating transitions of variable values in the control program 211, a generator 12 to generate a procedure including events occurring at the variables based on the log information, an output device 13 to output a data file 31 indicating the generated procedure, and a user interface (UI) 14 to function as an interface to a user 41.

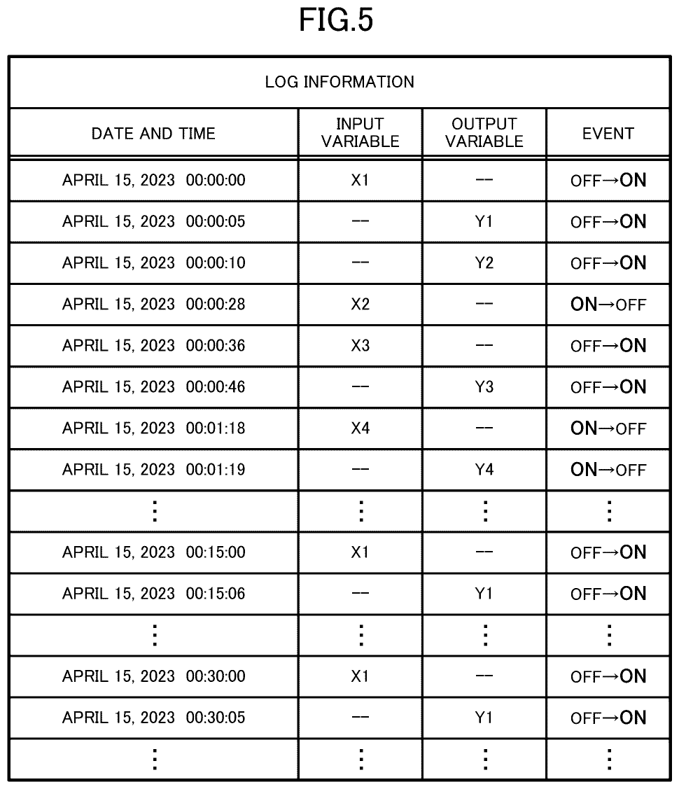

The log information acquirer 11 is mainly implemented by the communicator 106. The log information acquirer 11 receives, from the PLC 21, log information illustrated in FIG. 5 as an example. As illustrated in FIG. 5, the log information is a set of temporal records each associating a date and time, an identifier of a variable that is an output variable or an input variable, and an event occurring at the variable at the date and time with one another. In the example described below, all variables recorded in the log information each represent a 1-bit value, and each event is a change in the variable value from OFF to ON or from ON to OFF. OFF corresponds to zero. ON corresponds to 1.

The generator 12 is mainly implemented by the processor 101. The generator 12 generates a procedure including events recorded in the log information and connected in series, generates an event flowchart illustrating the generated procedure, and outputs the event flowchart to the output device 13 and the UI 14.

The output device 13 is mainly implemented by the processor 101 and the communicator 106 operating in cooperation with each other. The output device 13 may output the data file 31 to either a non-transitory recording medium detachably attached to the procedure generation device 10 such as a memory card or a storage connected through a field network or a local area network (LAN).

The UI 14 is mainly implemented by the input device 104 and the output device 105 operating in cooperation with each other. The UI 14 acquires information input by the user 41, provides the information to the generator 12, and causes the generator 12 to generate a procedure based on the information. The UI 14 also displays the event flowchart generated by the generator 12 to the user 41.

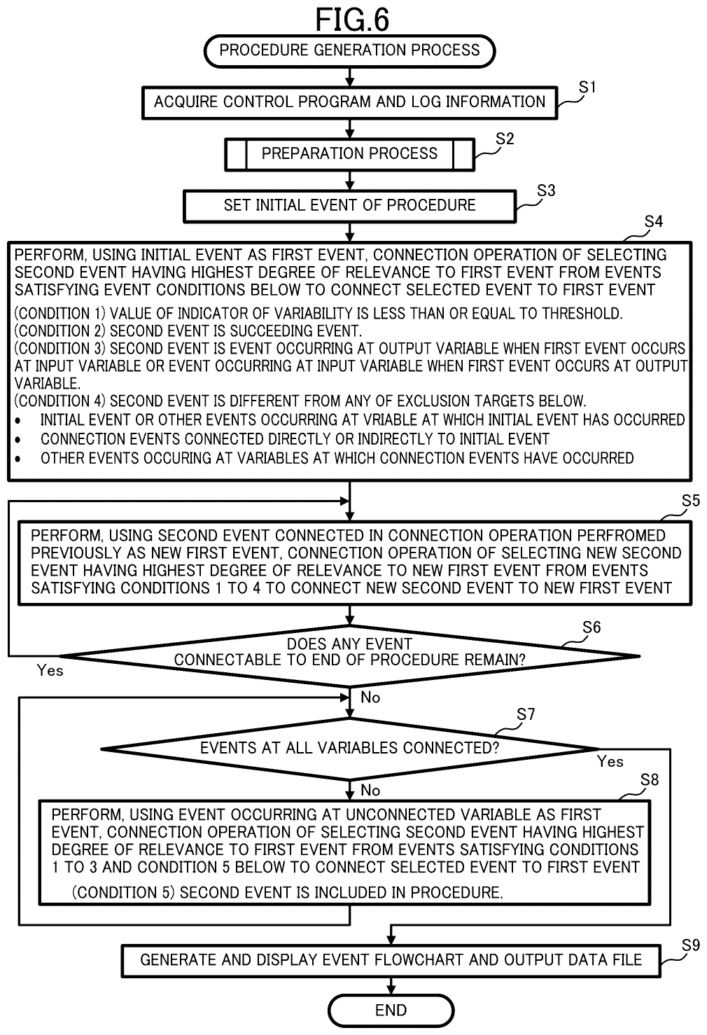

The procedure generation process performed by the procedure generation device 10 is described in detail with reference to FIGS. 6 to 13. The procedure generation process illustrated in FIG. 6 corresponds to an example of a procedure generation method implementable by the procedure generation device 10.

In the procedure generation process, the log information acquirer 11 acquires the control program 211 and the log information from the PLC 21 (step S1). The control program 211 may be a source code or an object-based program. The log information acquirer 11 corresponds to an example of log acquisition means for acquiring log information indicating transitions of values of multiple variables in the control program when the control program for controlling a machine is executed by a programmable controller. The generator 12 then performs a preparation process for generating a procedure (step S2).

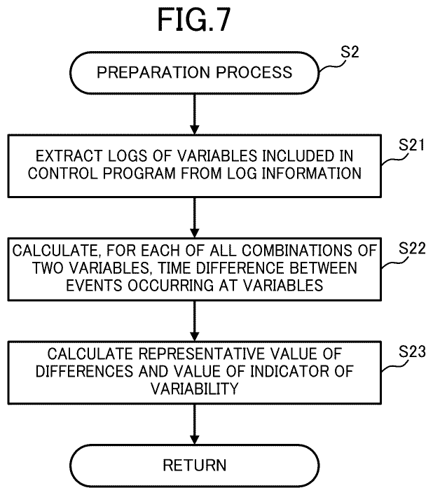

In the preparation process, as illustrated in FIG. 7, the generator 12 extracts logs of variables included in the control program 211 from the log information (step S21). More specifically, the generator 12 scans the control program 211, identifies all input variables and output variables used in the control program 211, and extracts the records associated with the identified variables from the log information. When the log information simply includes records relevant to the input variables and the output variables used in the control program 211, step S21 may be eliminated.

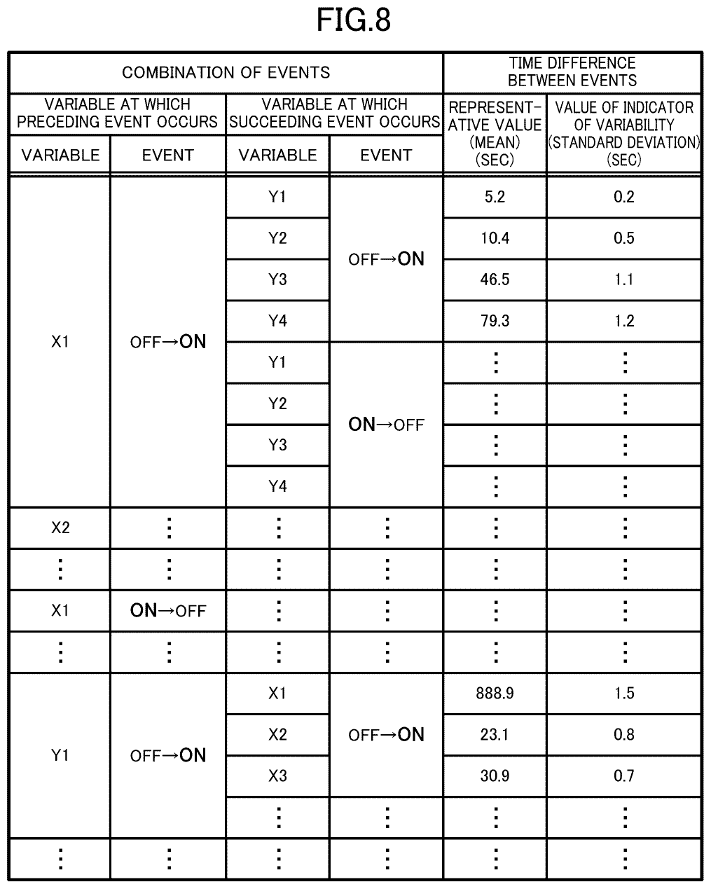

The generator 12 then calculates, for each of all combinations of two variables, a time difference between the two events occurring at the two variables (step S22). More specifically, the generator 12 calculates, for each of all combinations of events at input variables and events at output variables, a time difference in the log information. As illustrated in FIG. 8, for example, a preceding event at an input variable X1 that changes from OFF to ON and succeeding events at output variables Y1 to Y4 provide their eight combinations with two types of events occurring at each output variable. With four input variables X1 to X4, 64 combinations are provided in total, with two types of events occurring at each input variable and each output variable.

Referring back to FIG. 7, subsequent to step S22, the generator 12 calculates, for each combination of events, a representative value of the calculated differences and a value of an indicator of variability in the differences (step S23). As described above, the processes defined in the control program 211 are repeated. Each event can thus occur repeatedly. The time difference between a specific combination of two events is thus typically calculated multiple times. In the log information in FIG. 5, for example, the same event occurs repeatedly in a 15-minute cycle. Thus, a combination of the event at the input variable X1 turning ON and the succeeding event at the output variable Y1 turning ON is recorded multiple times. The other combinations are also recorded multiple times.

One preceding event is followed by a succeeding event occurring multiple times. For example, after the event at 00:00:00 at the input variable X1 turning ON, an event at the output variable Y1 turning ON occurs multiple times. However, a difference between the event at 00:00:00 and an event immediately after the event at 00:00:00 at the output variable Y1 turning ON may simply be calculated.

FIG. 8 illustrates, for each combination, an example calculated representative value of differences and an example value of an indicator of variability in the differences. The representative value herein is a mean. The value of an indicator of variability herein is a standard deviation. However, the representative value may be a median or a mode. The value of an indicator of variability may be a coefficient of variance.

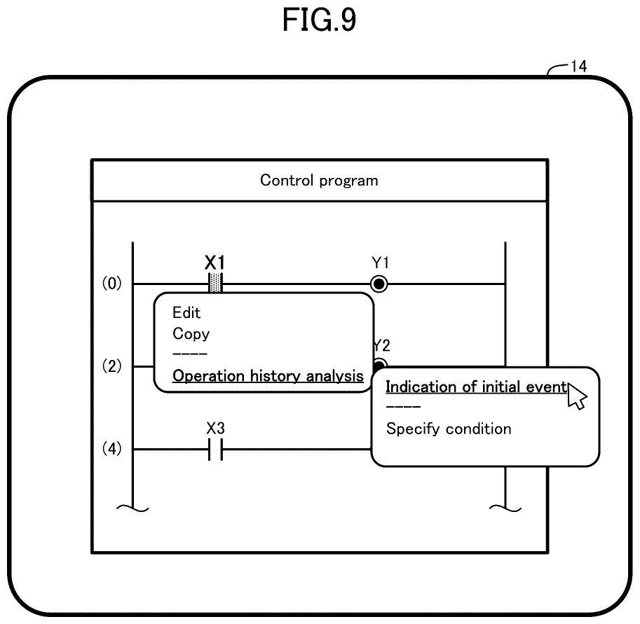

Referring back to FIG. 7, after step S23 is complete, the process performed by the procedure generation device 10 returns from the preparation process to the procedure generation process illustrated in FIG. 6. As illustrated in FIG. 6, subsequent to the preparation process in step S2, the procedure generation device 10 sets an initial event of a procedure (step S3). The initial event is a start of the procedure. The procedure generation device 10 receives an indication of the initial event from the user. As illustrated in FIG. 9, for example, the user clicks an input variable X1 in the control program displayed on the UI 14 to cause a submenu to appear. From the submenu, the user can specify an event at the input variable X1 as an initial event. The initial event may be an event occurring first at the variable specified as in FIG. 9. A type of event to be the initial event may further be specified by the user. The variable at which the initial event occurs corresponds to an example of an initial variable.

Referring back to FIG. 6, the generator 12 performs, using the initial event as a first event, a connection operation of selecting a second event having the highest degree of relevance to the first event from events satisfying event conditions that are Conditions 1 to 4 to connect the selected event to the first event (step S4).

Condition 1 is the value of an indicator of variability being less than or equal to a threshold. For example, when an event at the input variable X1 turning ON is set as an initial event and the threshold is 1.0, the combination of the initial event and an event at the output variable Y3 turning ON as illustrated in FIG. 8 has a standard deviation of 1.1. This value exceeds the threshold. The event at the output variable Y3 turning ON is thus not a selection target for the second event. The threshold may be specified by the user.

Condition 2 is the second event being a succeeding event. When an event at the input variable X1 turning ON is set as an initial event, events succeeding the initial event are selection targets for the second event. In FIG. 8, the succeeding events in the eight combinations with the preceding event at the input variable X1 turning ON satisfy Condition 2. However, for a combination including a succeeding event at the input variable X1 turning ON, Condition 2 is not satisfied.

Condition 3 is the second event being an event occurring at an output variable when the first event occurs at an input variable or being an event occurring at an input variable when the first event occurs at an output variable. When an event at the input variable X1 is set as an initial event, events at the output variables Y1 to Y4 are the selection targets for the second event. The other events at the input variable X1 and events at other input variables X2 to X4 are not the selection targets. As in the preparation process described above, when the representative values and the values of indicators of variability are calculated for the combinations of input variables and output variables, Condition 3 may be eliminated.

Condition 4 is the second event being different from any of the exclusion targets below. In other words, the second event is different from any of the initial event, other events occurring at a variable at which the initial event has occurred, connection events connected directly or indirectly to the initial event, and other events occurring at variables at which the connection events have occurred. In Condition 4 in step S4 with the event at the input variable X1 turning ON set as an initial event, the event at the input variable X1 is an exclusion target.

Among events illustrated in FIG. 8, for example, two events, or more specifically, the event at the output variable Y1 turning ON and the event at the output variable Y2 turning ON satisfy Conditions 1 to 4.

The generator 12 selects an event having the highest degree of relevance to the first event as the second event from events satisfying Conditions 1 to 4. The degree of relevance increases for a less representative value. The degree of relevance is expressed with, for example, a formula P=1/(Q+1), where P is the degree of relevance, and Q is the representative value. However, the degree of relevance may be expressed with another formula. The degree of relevance has a one-to-one correspondence with the representative value. The generator 12 may thus use the representative value as the degree of relevance. The generator 12 may select an event having the least representative value as the second event. In the example in FIG. 8, the event at the output variable Y1 turning ON is selected as the second event.

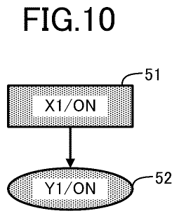

In this manner, as illustrated in FIG. 10, a node 52 representing the second event at the output variable Y1 turning ON is connected to a node 51 representing the first event at the input variable X1 turning ON. In FIG. 10, the nodes 51 and 52 are connected with an arrow indicating a temporal order, but a line other than the arrow may be used to connect these nodes. In FIG. 10, a square node corresponds to an input variable, and an oval node corresponds to an output variable. A node with hatching corresponds to an event at a variable turning ON.

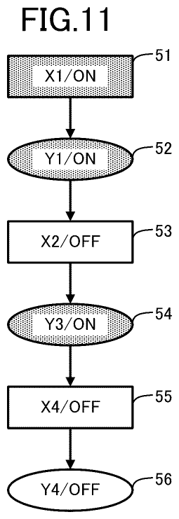

Referring back to FIG. 6, subsequent to step S4, the generator 12 performs, using the second event connected in the connection operation performed previously as a new first event, the connection operation of selecting a new second event having the highest degree of relevance to the new first event from events satisfying Conditions 1 to 4 to connect the new second event to the new first event (step S5). For example, in step S5 after the event at the output variable Y1 turning ON is connected to the initial event as in in FIG. 10, a connection operation that is the same as the operation in step S4 is repeated using the event corresponding to the node 52 as a new first event. In this manner, as illustrated in FIG. 11, a node 53 corresponding to an event at the input variable X2 turning OFF is connected to the node 52.

The connection operation performed in steps S4 and S5 corresponds to an example of a connection operation of selecting, based on the log information, a second event having the highest degree of relevance to the first event occurring at a first variable of the multiple variables from events occurring at a second variable different from the first variable to connect the second event to the first event.

Referring back to FIG. 6, subsequent to step S5, the generator 12 determines whether any event connectable to the end of the procedure remains (step S6). In other words, the generator 12 determines, when an event connected last is used as a new first event, whether any event satisfying Conditions 1 to 4 remains.

When the generator 12 determines that a connectable event remains (Yes in step S6), the generator 12 repeats the connection operation in step S5. This causes nodes 54 to 56 to be connected in sequence as illustrated in FIG. 11 and generates a procedure including events at the input variables and events at the output variables being alternated in series.

In step S6, when determining that no connectable event remains (No in step S6), the generator 12 determines whether events at all variables are connected in the procedure (step S7). In the example in FIG. 11, the procedure does not include an event at an input variable X3 and an event at the output variable Y2. Thus, the determination result in step S7 is negative.

When determining that the events at all variables are not connected (No in step S7), the generator 12 performs, using an event occurring at an unconnected variable as a first event, the connection operation of selecting a second event having the highest degree of relevance to the first event from events satisfying Conditions 1 to 3 and 5 to connect the selected event to the first event (step S8). For example, an event at the input variable X3 turning ON is set as a first event. Any method may be used for selecting one unconnected variable and for selecting the type of event relevant to the selected variable.

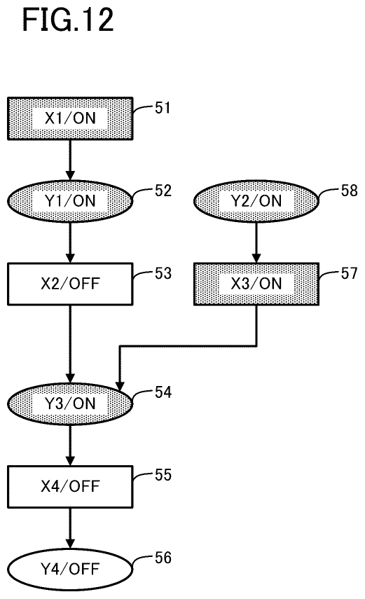

Condition 5 is a second event being included in the procedure. Thus, step S8 is performed for searching for a target event to which an unconnected event is to be connected. When an event corresponding to the node 54 is selected from events satisfying Conditions 1 to 3 and 5 as an event having the highest degree of relevance, a node 57 corresponding to an event at the input variable X3 turning ON is connected to the node 54 as illustrated in FIG. 12.

The generator 12 then repeats the determination in step S7. For every variable, an event is connected to the procedure. For example, a node 58 corresponding to the event at the output variable Y2 turning ON is connected to the node 57 as illustrated in FIG. 12.

When the determination in step S7 is repeated without any new event being connected, the generator 12 may eliminate or change a part of the conditions in step S8 to facilitate connection of an event to the procedure. For example, the generator 12 may increase the threshold in Condition 1 or may eliminate Condition 2. Further, when no new event is connected after the changes in the conditions, the generator 12 may determine that all connectable events have already been connected to the procedure and yield affirmative determination in step S7.

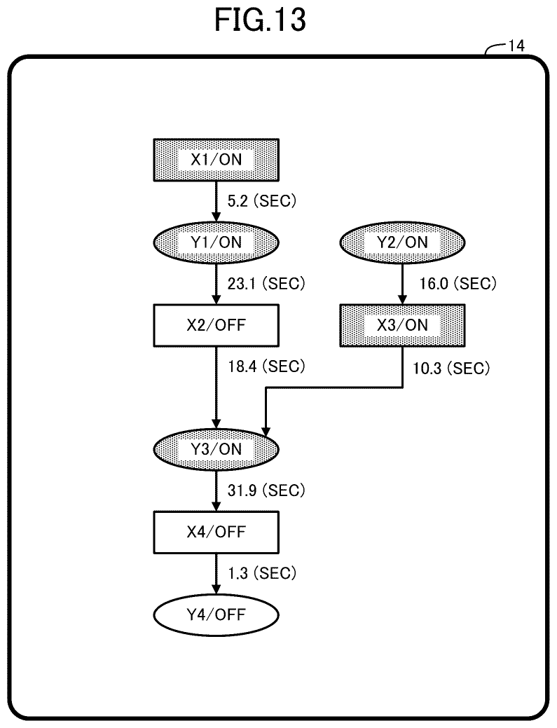

When determining that the events at all variables are connected to the procedure in step S7 (Yes in step S7), the generator 12 generates an event flowchart illustrating the generated procedure, causes the UI 14 to display the event flowchart, and causes the output device 13 to output a data file indicating the event flowchart (step S9). More specifically, as illustrated in FIG. 13, the UI 14 displays the event flowchart with arrows each connecting the corresponding nodes, and the representative value of the time differences between the corresponding events is indicated with the arrows. This allows the user 41 to easily identify an event that has occurred and the period of time after which the event has occurred. The output device 13 corresponds to an example of output means for outputting a data file indicating the event flowchart.

As described above, the generator 12 generates a procedure including two or more events connected in series by repeating the connection operation while excluding the initial event and events connected directly or indirectly to the initial event from selection targets for a new second event. This avoids a large number of combinations of variables in the control program 211 to be included in the procedure and thus can reduce the workload of a verification operation of the control program 211 executed by the PLC 21.

The degree of relevance indicating the level of relevance between events is higher for a less representative value of differences between a time at which the first event occurs and a time at which the second event occurs. The events occurring with a small time difference can typically be estimated to have a relationship. Thus, an appropriate procedure including events indicated by the log information may be acquired.

The connection operation is an operation of selecting the second event from events having values of indicators of variability in the time differences less the threshold. When the values of indicators are greater, the events have a weak relationship between them, thus avoiding inappropriate events connected to each other.

After generating the procedure including events connected in series, the generator 12 selects, from the events included in the procedure, an event having the highest degree of relevance to an unconnected event occurring at one of the multiple variables and not included in the procedure. The generator 12 then connects the unconnected event to the selected event to change the procedure. This allows the procedure to represent relationships among a maximum number of the variables.

The connection operation is an operation of connecting an output variable to an input variable and an input variable to an output variable. The PLC 21 typically controls the machine 22 in response to a received signal. In the control program in the PLC 21, the event at an output variable thus occurs in response to the event at an input variable. The PLC 21 also receives a new signal resulting from an operation on the external device by controlling the machine 22. Thus, an event at the input variable occurs in response to an event at the output variable. In this manner, the events at the input variables and the events at the output variables alternately affect each other, thus generating the procedure reflecting the actual state.

Each of the first event and the second event to be a target for the connection operation is an increment or a decrement of the 1-bit value. The increment herein corresponds to a change to an ON state, and the decrement corresponds to a change to an OFF state. The bit device often indicates the presence or absence of an input or an output in the control program 211, thus expectedly providing a procedure appropriately representing the order of determinations of the presence or absence of an input or an output.

The generator 12 generates a procedure by repeating, using the second event connected in the connection operation performed previously as a new first event, the connection operation while excluding, from selection targets for a new second event, the initial event, other events occurring at the variable at which the initial event has occurred, connection events connected directly or indirectly to the initial event, and other events occurring at variables at which the connection events have occurred. This generates a procedure in which one event is used for one variable. Not all events occurring at a variable may be meaningful. One type of event may typically be focused in many cases. The generated procedure is thus expected to exclude unintended events.

The procedure generation device 10 includes the output device 13 to output the data file 31 indicating the event flowchart. The event flowchart can thus be used easily. For example, a manual including the event flowchart can be created easily.

### Embodiment 2

Embodiment 2 is now described focusing on the differences from Embodiment 1 described above. Like reference signs denote like or corresponding components in Embodiment 1. The present embodiment differs from Embodiment 1 in that inappropriate values, among the sample values calculated as the time differences, are excluded and then appropriate representative values are calculated.

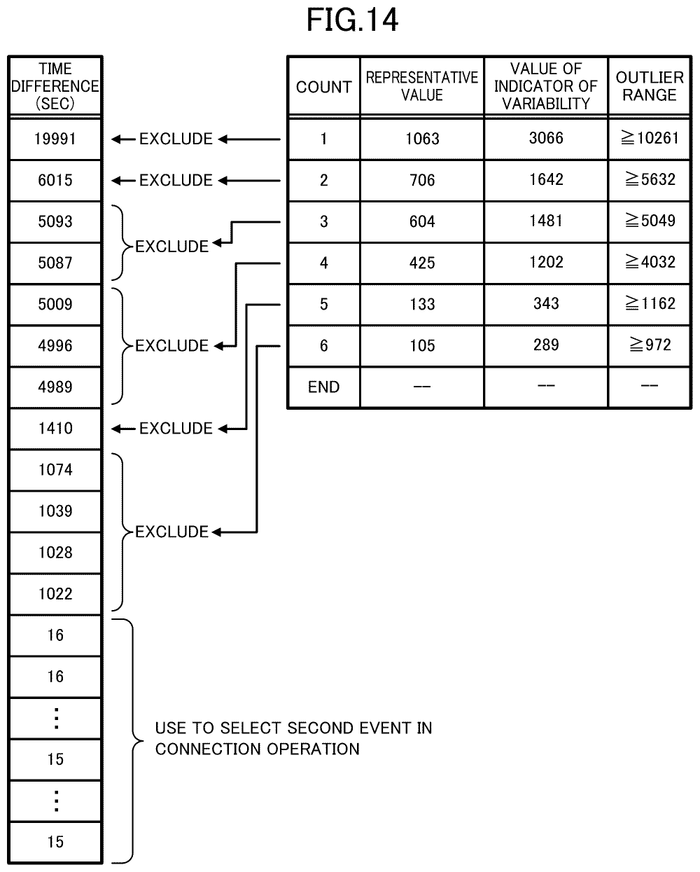

The control process defined in the control program 211 is to be performed cyclically, but may be temporarily stopped upon occurrence of an abnormality such as a momentary power failure. The log information includes logs recorded during such an exceptional period. Thus, the time differences calculated in the preparation process may include outliers largely different from 15 or 16 seconds recorded during regular operation periods as illustrated in FIG. 14.

The generator 12 thus detects the outliers in the distribution of time differences and calculates a representative value using one or more sample values of the time differences excluding the detected outliers from the sample values. For example, the generator 12 excludes the outliers with the 30 method. More specifically, the generator 12 calculates a mean and a standard deviation using all sample values of the time differences and repeats a process of excluding sample values that deviate from the mean by three or more times the standard deviation until no exclusion targets remain. In the example in FIG. 14, after the exclusion target determination is performed six times, sample values of more than or equal to 972 seconds are excluded as the outliers.

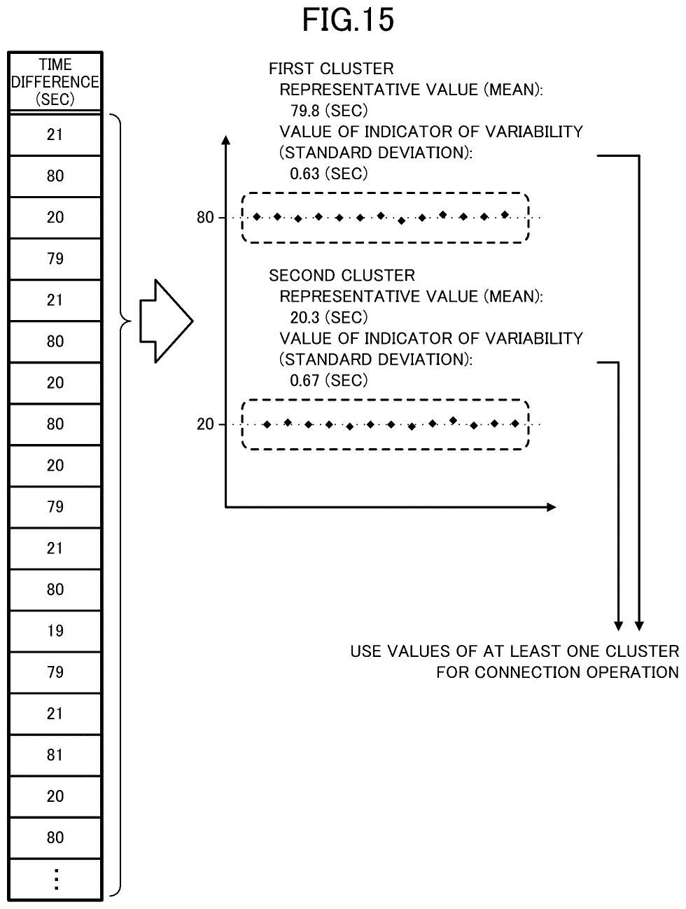

When one first event and one second event as the targets for the connection operation each occur once during the control process defined in the control program 211, the time difference between these events is substantially constant. However, when at least one of the first event or the second event occurs two or more times during the control process, the time difference may not always be constant. As illustrated in FIG. 15, for example, the same combination of events may alternately have a time difference of about 20 seconds and a time difference of about 80 seconds.

The generator 12 thus calculates a representative value based on the results of clustering sample values of the time differences. For example, the generator 12 performs k-means clustering and calculates a representative value and a value of an indicator of variability for each cluster. The generator 12 uses the representative value and the value of the indicator of variability of at least one cluster for the connection operation. For example, the generator 12 may use a cluster with a least representative value, a cluster with a least value of an indicator of variability, or a weighted average of all cluster values.

As described above, the generator 12 detects the outliers in the distribution of time differences and calculates a representative value from one or more sample values of time differences excluding the detected outliers from the sample values. In this manner, an appropriate representative value can be calculated, thus generating the procedure reflecting the actual state.

The generator 12 calculates a representative value based on the results of clustering the sample values of time differences. For example, when a representative value of the distribution including two clusters as illustrated in FIG. 15 is calculated in the same manner as in Embodiment 1, the resulting representative value rarely appears in the actual log information. In contrast, the generator 12 in the present embodiment calculates a representative value based on the results of clustering and can thus acquire the representative value reflecting the actual state.

### Embodiment 3

Embodiment 3 is now described focusing on the differences from Embodiment 1. Like reference signs denote like or corresponding components in Embodiment 1. The present embodiment differs from Embodiment 1 in that the log information does not include dates and times, and time differences are not used in the connection operation.

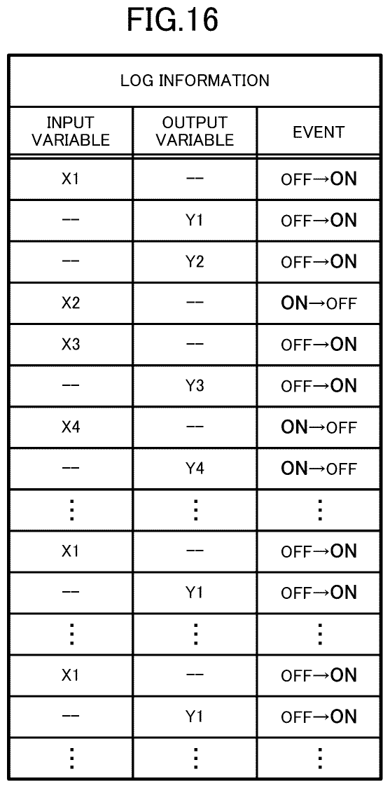

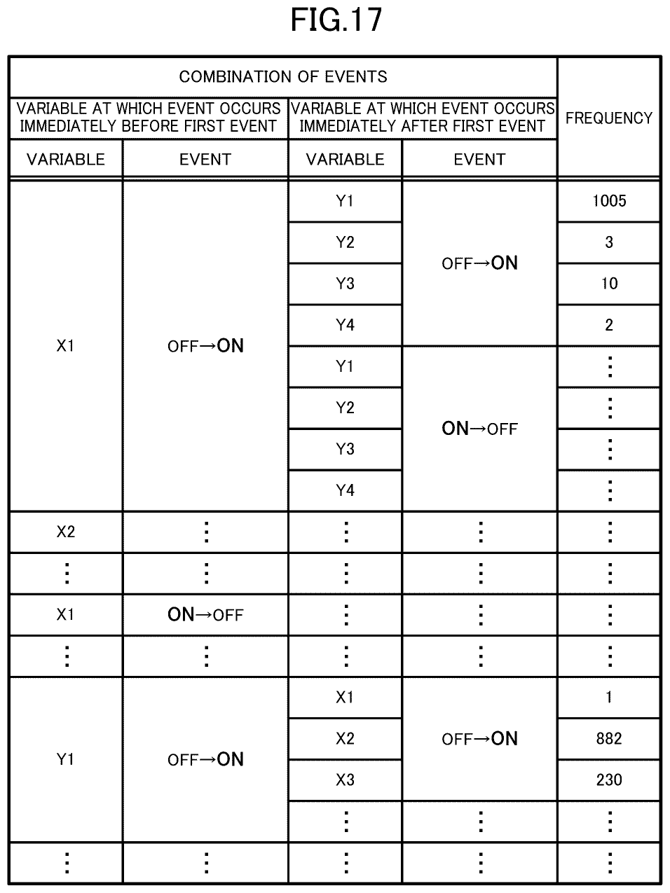

The log information in the present embodiment corresponds the log information in Embodiment 1 excluding dates and times as illustrated in FIG. 16. Based on the log information, the preparation process counts, for every combination of two events, the frequency of the two events occurring consecutively without any other event occurring in between as illustrated in FIG. 17. The generator 12 performs the connection operation using the frequency as a degree of relevance. This generates the same procedure as the procedure in Embodiment 1. For the connection operation, the determination under Condition 1 illustrated in FIG. 6 is eliminated.

As described above, in the connection operation, a second event having the highest degree of relevance to the first event occurs immediately after the first event more frequently than other events. This allows generation of the procedure with the logs excluding time records.

Although the embodiments of the present disclosure are described above, the present disclosure is not limited to the above embodiments.

In Embodiments 1 and 2, for example, the format of the log information may not be limited to a format that associates occurring events with their occurrence times. The log information may be recorded, independently of the presence or absence of an event, at a shorter sampling cycle than a control process cycle. Based on such log information, the preparation process may determine the presence or absence of an event. The log information directly or indirectly indicates the transitions of variable values when the PLC 21 executes the control program.

In the examples described above, the log information acquirer 11 acquires the log information from the PLC 21. However, the structure is not limited to this example. The log information acquirer 11 may acquire the log information provided by the user.

In the examples described above, the procedure is generated using the events at all variables included in the control program 211. However, the processing is not limited to these examples. The UI 14 may receive an indication of a partial program corresponding to a part of the control program from the user, and the generator 12 may generate a procedure for variables included in the partial program. The UI 14 corresponds to an example of user interface means for receiving the indication of the partial program included in the control program.

The conditions for determination in the connection operation may be changed as appropriate. For example, Condition 3 for alternately connecting events at the input variables and events at the output variables may be eliminated. Thus, the event at an input variable may be connected to the event at another input variable, or the event at an output variable may be connected to the event at another output variable.

In the examples described above, one type of event is used for one variable to generate a procedure. However, the processing is not limited to these examples. For example, a procedure may be generated using all events for variables specified by the user. In other words, the exclusion targets in Condition 4 described in FIG. 6 may be used as the initial event and connection events connected to the procedure.

The generator 12 corresponds to generation means for generating a procedure including two or more events connected in series to generate an event flowchart illustrating the generated procedure by performing a connection operation using an initial event occurring at an initial variable of the multiple variables as a first event and by repeating, using the second event connected in the connection operation performed previously as a new first event, the connection operation while excluding the initial event and an event connected directly or indirectly to the initial event from selection targets of a new second event.

In Condition 2, a second event succeeding the first event may be changed to a second event preceding to the first event. In some embodiments, Condition 2 may be eliminated. In the above embodiments, Condition 2 defines a second event being a succeeding event. Thus, the events succeeding the initial event are sequentially connected, generating a procedure including the events occurring after the initial event. This procedure includes events reflecting the effects of the initial event. In contrast, when Condition 2 is changed to define a second event being a preceding event, events preceding the initial event are sequentially connected. Thus, the generated procedure tracks the events that have caused the initial event.

Also in the connection operation in Embodiment 3, the second event having the highest degree of relevance to the first event may be used as an event occurring immediately before the first event more frequently than other events.

In the examples described above, an increment and a decrement in the 1-bit value are different events. However, the increment and the decrement may not be distinguished from each other and the change in the value may be used as one type of event. The events occurring in a bit device is not limited to an increment or a decrement in the value and may be changed to or include other events. The other events may be, for example, the ON value or the OFF value being maintained longer than a specified period.

The events included in the procedure may occur in a word device, rather than in a bit device.

The functions of the procedure generation device 10 according to the above embodiments can be implemented by a dedicated hardware device or by a common computer system.

For example, the program P1 may be stored in a non-transitory computer-readable recording medium, typically a flexible disc, a compact disc read-only memory (CD-ROM), a digital versatile disc (DVD), or a magneto-optical (MO) disk, and may be distributed. The program P1 can be installed in a computer to provide a device that performs the above processing.

The program P1 may be stored in a disk device included in a server on a communication network, typically the Internet, and may be, for example, superimposed on a carrier wave to be downloaded to a computer.

The processing described above may also be performed by the program P1 being activated and executed while being transferred through a network, typically the Internet.

The processing described above may also be performed by entirely or partially executing the program P1 on a server while a computer is transmitting and receiving information about the processing through a communication network.

In the system with the above functions implementable partially by the operating system (OS) or through cooperation between the OS and applications, portions executable by applications other than the OS may be stored in a non-transitory recording medium that may be distributed or may be downloaded to a computer.

Means for implementing the functions of the procedure generation device 10 is not limited to software, and may be partially or entirely implemented by dedicated hardware or a dedicated circuit.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

### INDUSTRIAL APPLICABILITY

One or more embodiments of the present disclosure are applicable to the verification operation of control programs used at an FA site.

### REFERENCE SIGNS LIST

10 Procedure generation device
11 Log information acquirer
12 Generator
13 Output device
14 UI
101 Processor
102 Main storage
103 Auxiliary storage
104 Input device
105 Output device
106 Communicator
107 Internal bus
21 PLC
211 Control program
22 Machine
31 Data file
41 User
51 to 58 Node
P1 Program

1. A non-transitory computer-readable recording medium storing a procedure generation program, the procedure generation program causing a computer to function as:
log acquirer to acquire log information indicating transitions of values of a plurality of variables in a control program when the control program for controlling a machine is executed by a programmable controller; and
generator to generate a procedure including two or more events connected in series to generate an event flowchart illustrating the generated procedure by performing, using an initial event occurring at an initial variable of the plurality of variables as a first event occurring at a first variable of the plurality of variables, a connection operation of selecting, based on the log information, a second event having a highest degree of relevance to the first event from events occurring at a second variable different from the first variable to connect the second event to the first event, and by repeating, using the second event connected in the connection operation performed previously as a new first event, the connection operation while excluding the initial event and an event connected directly or indirectly to the initial event from selection targets for a new second event.

2. The non-transitory computer-readable recording medium according to claim 1, wherein
the log information indicates, in a manner associated with time, transitions of values of the plurality of variables when a process defined by the control program is repeatedly performed by the programmable controller, and
the degree of relevance is higher for a less representative value of differences between a time at which the first event occurs and a time at which the second event occurs.

3. The non-transitory computer-readable recording medium according to claim 2, wherein
the connection operation is an operation of selecting the second event from events having values of indicators of variability in the differences less than a threshold.

4. The non-transitory computer-readable recording medium according to claim 3, wherein
after generating the procedure, the generator selects, from the events included in the procedure, an event having a highest degree of relevance to an unconnected event occurring at one of the plurality of variables and not included in the procedure and connects the unconnected event to the selected event to change the procedure.

5. The non-transitory computer-readable recording medium according to claim 2, wherein
the generator detects an outlier in a distribution of the differences and calculates the representative value using one or more differences excluding the detected outlier from the differences.

6. The non-transitory computer-readable recording medium according to claim 2, wherein
the generator calculates the representative value based on a result of clustering a plurality of sample values of the differences.

7. The non-transitory computer-readable recording medium according to claim 2, wherein
the event flowchart illustrates the procedure using nodes corresponding to events and a line connecting the nodes corresponding to the connected events, and the representative value is indicated with the line.

8. The non-transitory computer-readable recording medium according to claim 1, wherein
the log information indicates transitions of values of the plurality of variables when a process defined by the control program is repeatedly performed by the programmable controller, and
the second event having a highest degree of relevance to the first event occurs immediately before or after the first event more frequently than other events.

9. The non-transitory computer-readable recording medium according to claim 1, wherein
when the first variable is an input variable corresponding to an input into the programmable controller, the second variable is an output variable corresponding to an output from the programmable controller to the machine, and
when the first variable is the output variable, the second variable is the input variable.

10. The non-transitory computer-readable recording medium according to claim 1, wherein
each of the first variable and the second variable represents a 1-bit value, and each of the first event and the second event is a change in the 1-bit value.

11. The non-transitory computer-readable recording medium according to claim 10, wherein
each of the first event and the second event is an increment or a decrement of the 1-bit value.

12. The non-transitory computer-readable recording medium according to claim 1, wherein
the generator generates the procedure by repeating, using the second event connected in the connection operation performed previously as a new first event, the connection operation while excluding, from selection targets for a new second event, an event occurring at the initial variable, a connection event connected directly or indirectly to the initial event, and another event occurring at a variable at which the connection event has occurred.

13. The non-transitory computer-readable recording medium according to claim 1, causing the computer to further function as:
user interface for receiving an indication of a partial program included in the control program,
wherein the plurality of variables are included in the partial program.

14. The non-transitory computer-readable recording medium according to claim 1, causing the computer to further function as:
outputter to output a data file indicating the event flowchart.

15. A procedure generation device, comprising:
log acquirer to acquire log information indicating transitions of values of a plurality of variables in a control program when the control program for controlling a machine is executed by a programmable controller; and
processing circuitry to generate a procedure including two or more events connected in series to generate an event flowchart illustrating the generated procedure by performing, using an initial event occurring at an initial variable of the plurality of variables as a first event occurring at a first variable of the plurality of variables, a connection operation of selecting, based on the log information, a second event having a highest degree of relevance to the first event from events occurring at a second variable different from the first variable to connect the second event to the first event, and by repeating, using the second event connected in the connection operation performed previously as a new first event, the connection operation while excluding the initial event and an event connected directly or indirectly to the initial event from selection targets for a new second event.

16. A procedure generation method, comprising:
acquiring, with log acquirer, log information indicating transitions of values of a plurality of variables in a control program when the control program for controlling a machine is executed by a programmable controller;
generating, with generator, a procedure including two or more events connected in series by performing, using an initial event occurring at an initial variable of the plurality of variables as a first event occurring at a first variable of the plurality of variables, a connection operation of selecting, based on the log information, a second event having a highest degree of relevance to the first event from events occurring at a second variable different from the first variable to connect the second event to the first event, and by repeating, using the second event connected in the connection operation performed previously as a new first event, the connection operation while excluding the initial event and an event connected directly or indirectly to the initial event from selection targets for a new second event; and
generating, with the generator, an event flowchart illustrating the generated procedure.
